(19) United States
(12) Patent Application Publication
(10) Pub. No.: US 2026/0364487 A1
(43) Pub. Date: Nov. 19, 2026

(54) SELECTIVE ION EXTRACTION SYSTEM

(71) Applicant: Schlumberger Technology Corporation, Sugar Land, TX (US)

(72) Inventors: Florence Binet, Houston, TX (US); Dominic Vincent Perroni, Sugar Land, TX (US)

(21) Appl. No.: 19/211,453

(22) Filed: May 19, 2025

(51) Int. Cl. B01D 15/36; B01D 61/00; B01D 69/02; B01J 20/22

(52) U.S. Cl. CPC B01D 15/361; B01D 61/0024; B01D 69/02; B01J 20/226; B01D 2311/2623; B01D 2323/21811; B01D 2325/0283; B01D 2325/42

(57) ABSTRACT

An ion extraction system may include an extraction tube. An ion extraction system may include an elective membrane at the extraction tube, the elective membrane formed from a material to selectively transport a target ion from a brine in the extraction tube. An ion extraction system may include an extraction chamber surrounding at least a portion of the extraction tube, wherein an eluent in the extraction chamber is configured to extract the target ion from the brine.

### BACKGROUND OF THE DISCLOSURE

Metal-organic frameworks (MOFs) are porous crystalline materials prepared by the self-assembly of metal ions and organic ligands. MOFs can have large pore volumes and apparent surface areas as high as 8,000 m²/g. MOFs combine a structural and chemical diversity that make them attractive for many potential applications, including adsorption of an element of interest. The host/guest interaction of the MOF may be built by choosing the appropriate building blocks, i.e., the metal ions and organic ligands, from which the MOF is formed.

Extracting an element of interest, such as lithium, nickel, cobalt, etc. from an aqueous feed using an adsorption/desorption process has been previously performed in the mining industry. In such adsorption/desorption processes, an extraction feed is contacted with the sorbent material in a vessel or a plurality of vessels in order to load the element of interest into the sorbent material. A depleted stream—i.e., extraction feed, stripped from the element of interest, is then removed from the vessel in order to be separated from the sorbent material and an eluent is circulated into the vessel so that the element of interest unloads from the sorbent and loads into the eluent, forming an eluate i.e., the eluent loaded with the element of interest.

### SUMMARY

In some aspects, the techniques described herein relate to an ion extraction system. The ion extraction system includes an extraction tube and an elective membrane at the extraction tube. The elective membrane is formed from a material to selectively transport a target ion from a brine in the extraction tube. An extraction chamber surrounds at least a portion of the extraction tube. An eluent in the extraction chamber is configured to extract the target ion from the brine.

In some aspects, the techniques described herein relate to a method for selective ion extraction. An operator flows a brine through an interior of an extraction tube. The extraction tube includes a material configured to selectively transport a target ion from the brine. The operator flows an eluent across an outer surface of the extraction tube such that at least a portion of the target ion transfers from the interior of the extraction tube, across a wall of the extraction tube, and into the eluent.

In some aspects, the techniques described herein relate to an ion extraction system. The ion extraction system includes a first fluid processing system arranged to pump a brine from a target ion rich storage to a target ion lean storage. The brine includes a target ion. The first fluid processing system includes at least one extraction tube between the target ion rich storage and the target ion lean storage. A second fluid processing system is arranged to pump an eluent from an eluent storage to an eluate storage. The second fluid processing system includes a chamber at least partially surrounding the at least one extraction tube. The chamber is located between the eluent storage and the eluate storage. The at least one extraction tube includes an elective membrane selected to selectively transport the target ion from the brine to the eluent in the chamber.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a schematic representation of an ion extraction system, according to at least one embodiment of the present disclosure.

FIG. 2 is a schematic representation of an ion extraction system, according to at least one embodiment of the present disclosure.

FIG. 3 is a schematic representation of an ion extraction system, according to at least one embodiment of the present disclosure.

FIG. 4 is a schematic representation of an ion extraction system, according to at least one embodiment of the present disclosure.

FIG. 5 is a schematic representation of an ion extraction system, according to at least one embodiment of the present disclosure.

FIG. 6 is a representation of a cross-sectional view of an extraction tube, according to at least one embodiment of the present disclosure.

FIG. 7 is a schematic representation of a cross-sectional view of an ion extraction system, according to at least one embodiment of the present disclosure.

FIG. 8 is a flowchart of a sample method for selective ion extraction, according to at least one embodiment of the present disclosure.

### DETAILED DESCRIPTION

This disclosure generally relates to devices, systems, and methods for the extraction and/or concentration of a target ion from a brine. An ion extraction system may include one or more extraction tubes. The extraction tubes may include and/or be coated with a material selected and/or designed to selectively transport the target ion from the brine in the extraction tubes to an eluent or other fluid in an extraction chamber surrounding the extraction tube. The material from the extraction tubes may include, for example, a metal-organic framework (MOF) having a composition that is selected to facilitate the passing of the target ion from the brine to the eluent. The brine may be flowed through the extraction tubes until the concentration of the target ion has depleted below a threshold concentration. In this manner, the ion extraction system may facilitate the extraction and/or concentration of the target ion from the brine.

The ion extraction system may facilitate the extraction of the target ion in any manner. For example, the ion extraction system may extract the target ion based on a difference physical pressure (e.g., hydraulic pressure), in which the brine is pumped through the one or more extraction tubes with a hydraulic pressure that may cause the transfer of the target ion across the material. In some examples, the ion extraction may extract the target ion based on a difference in osmotic pressure, in which the concentration of the target ion (and/or other ions of the same charge) in the eluent is different than the concentration in the brine. In some examples, the ion extraction system may extract the target ion based on a difference in chemical potential, in which the chemical composition of the eluent is different than the chemical composition of the brine. In some examples, the ion extraction system may extract the target ion with an external field such as an external electrostatic field or a magnetic field.

As discussed herein, the extraction tubes may include a MOF or other material which may facilitate the selective extraction of the target ion. The MOF may be formed from monolithic MOF bodies. The MOF bodies discussed herein may include one or more MOF crystals having a composition designed to selectively transport one or more elements of interest from an aqueous solution. The MOF crystals may be monolithic crystals having a monolithic body with a volume over 0.01 mm³.

By “selectively transporting,” the MOF body extracts one or more elements of interest of a solution, the solution further containing additional elements (such as ions) that are not extracted or extracted at a lower concentration. In other words, the MOF body can be used to extract an element of interest from a solution containing several elements or compounds (for instance, extracting from a nickel-cobalt solution), such that a ratio of a concentration of the one or more elements of interest to the concentration of the one or more additional ions significantly increases after the selective extraction.

In particular, the MOF crystals have a composition that is selected to extract an ion from solution, including, but not limited to, one or more of lithium (Li), nickel (Ni), cobalt (Co), bromine (Br), uranium (U), copper (Cu), zinc (Zn), chromium (Cr), molybdenum (Mo), manganese (Mn), rare earth metals, palladium (Pd), lead (Pb), mercury (Hg), cadmium (Cd), thorium (Th), selenium (Se), fluorine (F), aluminum (Al), gallium (Ga), platinum (Pt), neodymium (Nd), dysprosium (Dy), terbium (Tb), praseodymium (Pr), iridium (Ir), boron (B), and so forth from a solution. In some examples, the MOF crystals may have a composition that is selected for use in mining or mineral extraction. In some examples, the MOF crystals may have a composition that is selected for use in water purification. As a specific, non-limiting example, the element of interest to extract may be lithium.

The MOF composition may have a composition that comprises a plurality of MOF crystals, where a first MOF crystal is configured to extract a first element of interest, for instance lithium (Li), and a second MOF crystal is configured to extract a second element of interest, for instance copper (Cu), nickel (Ni), cobalt (Co), boron (B), or bromide (Br).

In one embodiment, the MOF body may include one or more MOF crystals as well as a bonding agent.

The MOF crystals may be monocrystals. For example, the MOF crystals may be formed, grown, or deposited in a manner that may form a single monolithic crystal structure. The monolithic crystal structure of the MOF may include a single crystal having a consistent crystal structure throughout the crystal volume of the crystal body. In some embodiments, the monolithic crystals may include intentional defects. For example, the monolithic crystals may include intentional defects such as cracks, voids, or imperfection in the regular geometrical arrangement of the atoms in a crystalline solid, or other defects that may enhance the performance of the MOF.

The MOF body may include a bonding agent (e.g., a bonding agent). In accordance with at least one embodiment of the present disclosure, the bonding agent may facilitate the aggregation of multiple MOF crystals into a larger structure (e.g., the MOF body).

In accordance with at least one embodiment of the present disclosure, the composition of the bonding agent may be configured to facilitate attraction or transport of the target metal ions to the MOF crystals. For example, the composition of the bonding agent may include a MOF. In some examples, the bonding agent may include a MOF having the same composition as the MOF crystals in the MOF body. In some embodiments, the bonding agent may include a MOF having substantially the same composition as the MOF crystals in the MOF body. In some embodiments, the bonding agent may include a MOF having a different composition than the MOF crystal. For example, the bonding agent may include a MOF having a composition selected to attract different ions than the MOF crystal. In some embodiments, the bonding agent may include multiple MOFs.

In some embodiments, the MOF in the bonding agent may be formed in a non-crystallized or amorphous state. In some embodiments, the MOF in the bonding agent may be formed with microcrystals, or crystals having a volume of less than 0.001 mm³ and/or having a smaller volume than the volume of the MOF crystals.

The bonding agent may include one or more features or functionality based on the content of the MOF and/or the additives to the bonding agent. For example, the bonding agent may be configured so that its properties (including the pore size and/or permeability) are tuned to limit residual water in the MOF body. This may help to increase the efficiency and/or effectiveness of the MOF body. In some embodiments, the porosity of the bonding agent may facilitate exposure to the MOF crystals to the solution.

In some embodiments, the bonding agent may include an attractant for the targeted metallic ion of interest. As a specific, non-limiting example, the bonding agent may include a sulfonate that results in high conductivity of the metallic ion of interest through the bonding agent to the MOF crystals. In some embodiments, the bonding agent may have low conductivity for other metallic ions. This may increase the purity of the resulting concentrated stream.

In some embodiments, the bonding agent may include an ion-sieve property. For example, the bonding agent may include pore sizes that prevent non-target ions from passing therethrough. For example, the bonding agent and/or the MOF crystals may include pore sizes of less than 1 nm to facilitate the passage of Li⁺ ions and selectively prevent the passage of Mg²⁺ ions. In some examples, selectivity between ions may be based on the valence of the ions. For example, the bonding agent may facilitate selective extraction of monovalent ions compared to divalent ions.

As discussed herein, a group or cluster of MOF crystals may be connected via a bonding agent or other connection medium. In some embodiments, the crystal structure of the monocrystals of the MOF may have an orientation. The orientation of the MOF crystals may be the longest direction of the MOF crystals, or a direction of one or more faces or edges of the MOF crystals. In some embodiments, when the MOF crystals are connected by the bonding agent, the MOF crystals may be oriented along different directions. For example, the MOF crystals may have a random orientation. In some examples, the MOF crystals may be arranged in any manner, including arranged in any orientation in the x, y, and z directions. In some embodiments, the MOF crystals may be oriented perpendicular to an outer surface of the bonding agent. In some embodiments, the MOF crystals may be oriented parallel or approximately parallel to the outer surface of the bonding agent. In some embodiments, the MOF crystals may be oriented to increase the surface area of the MOF crystals exposed to the solution.

The MOF body has mechanical properties that are stronger in comparison with the corresponding mechanical properties of the MOF crystals, such as a greater Young's modulus, and/or a greater density. The MOF body also has a stability over time that is greater in comparison with the MOF crystals.

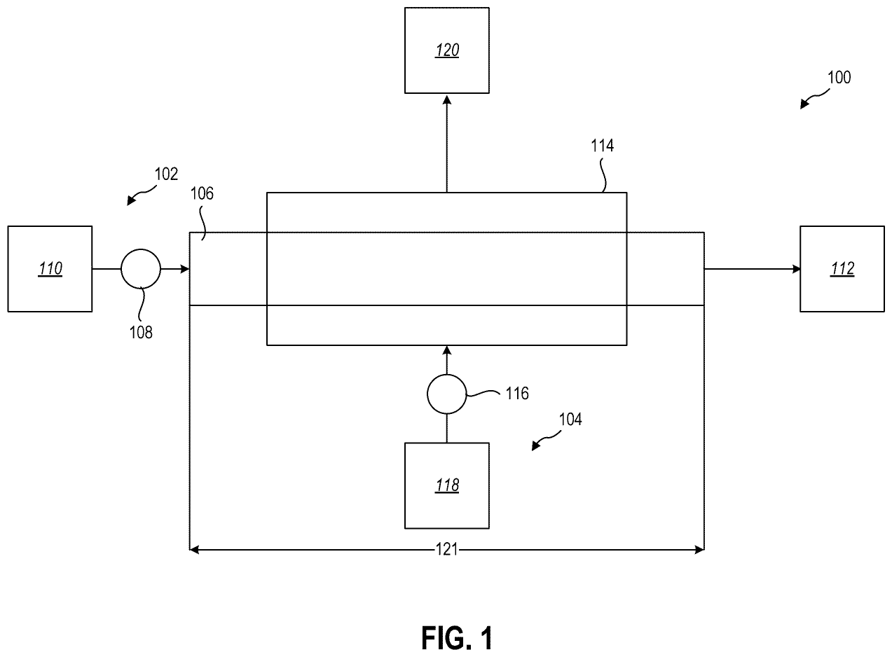

FIG. 1 is a schematic representation of an ion extraction system 100, according to at least one embodiment of the present disclosure. The ion extraction system 100 includes a first fluid processing system 102 and a second fluid processing system 104. The first fluid processing system 102 may be a brine processing system. For example, the first fluid processing system 102 may be arranged to pump a brine through one or more extraction tubes 106. The first fluid processing system 102 may include a brine pump 108 that is arranged to pump the brine from a target ion rich storage 110 to a target ion lean storage 112.

The second fluid processing system 104 may be arranged to pump an eluent through an extraction chamber 114. The extraction chamber 114 may at least partially surround the extraction tube 106. For example, when the eluent is pumped into the extraction chamber 114, the eluent may contact the outer surface of the extraction tube 106. This may facilitate transfer of the target ion from an interior of the extraction tube to the interior of the extraction chamber 114.

As discussed herein, the extraction tube 106 may include an elective membrane. The elective membrane may include a material configured to or designed to facilitate the selective extraction of the target ion from the interior of the extraction tube 106 to the eluent in the extraction chamber 114. In some embodiments, the material of the elective membrane may include a MOF, such as a MOF formed on a membrane or other structure that forms the extraction tube 106. The MOF may be selected to attract and extract or facilitate the transfer of the target ion across the outer surface of the extraction tube 106 as explained hereinabove.

The second fluid processing system 104 may include an eluent pump 116. The eluent pump 116 may be arranged to pump an eluent from an eluent storage 118 to an eluate storage 120. For example, the eluent pump 116 may pump the eluent from the eluent storage 118 into the extraction chamber 114. The eluent may at least partially fill the extraction chamber 114. For example, the eluent may fill and contact at least a portion of the extraction tube 106, in particular the elective membrane. In some examples, the eluent may contact or surround the outer surface of the extraction tube 106 in the extraction chamber 114.

A difference in energy between the brine in the extraction tube 106 and the eluent in the extraction chamber 114 may cause the target ion in the brine to transfer across the elective membrane (e.g., the MOF) at the outer surface of the extraction tube 106 and into the eluent in the extraction chamber 114. The difference in energy between the brine in the extraction tube 106 and the eluent in the extraction chamber 114 may be generated in any manner. For example, the eluent may include a fluid that has an eluent concentration of the target ion that is lower than a brine concentration of the target ion in the brine. This may facilitate the transfer of the target ion from the extraction tube 106 to the extraction chamber 114 across the MOF forming the outer surface of the extraction tube 106. In some examples, the pore size of the MOF may be selected to allow the transfer of ions having an ion size smaller than the pore size, but prevent the transfer of ions having an ion size larger than the pore size across the MOF. The higher brine concentration of the target ion in the brine and the relatively lower eluent concentration of the target ion in the eluent may result in at least some of the target ions transferring from the brine in the extraction tube 106 to the eluent in the extraction chamber 114.

In some embodiments, at least a portion of the energy for the extraction may be generated through a pressure differential between brine in the interior of the extraction tube 106 and the surrounding eluent in the extraction chamber 114. For example, the brine pump 108 may pump the brine through the extraction tube 106 with a brine pressure. The eluent pump 116 may pump the eluent through the extraction chamber 114 with an eluent pressure. The brine pressure may be greater than the eluent pressure sufficient to facilitate the transfer of the target ion across the walls of the eluent pump 116.

The brine pressure in the extraction tube 106 may be selected or designed to facilitate the efficient extraction of the target ion from the brine. In some embodiments, the brine pressure may be in a range having an upper value, a lower value, or upper and lower values including any of 1 Pa, 5 Pa, 10 Pa, 50 Pa, 100 Pa, 500 Pa, 1 kPa, 5 kPa, 10kPa, 50 kPa, 100 kPa, 500 kPa, 1 MPa, 2 MPa, 4 MPa, 8 MPa, 10 MPa, 15 MPa, 20 MPa, 25 MPa, 30 MPa or any value therebetween. For example, the brine pressure may be greater than 1 Pa. In another example, the brine pressure may be less than 30 MPa. In yet other examples, the brine pressure may be any value in a range between 1 Pa and 30 MPa. In some embodiments, it may be critical that the brine pressure is between 1 MPa and 30 MPa to increase the efficiency of the extraction of the target ion from the brine.

In some embodiments, the brine pressure may be based at least partially on the tube diameter of the extraction tube 106 and/or a tube length 121 of the extraction tube 106. In some embodiments, the brine pressure may be based on the structural strength of the extraction tube 106, including the strength of the elective membrane and/or the structural support of the extraction tube 106.

In some embodiments, the tube length 121 may be in a range having an upper value, a lower value, or upper and lower values including any of 1 cm, 5 cm, 10 cm, 50 cm, 100 cm, 500 cm, 1 m, 5 m, 10 m, or any value therebetween. For example, the tube length 121 may be greater than 1 cm. In another example, the tube length 121 may be less than 10 m. In yet other examples, the tube length 121 may be any value in a range between 1 cm and 10 m. In some embodiments, it may be critical that the tube length 121 is between 1 m and 5 m to facilitate efficient extraction of the target ion from the brine. In some embodiments, the tube length 121, tube diameter, and the brine pressure may be adjusted to reduce the power consumption, pressure drop, and increase the efficiency of the target ion while maintaining manufacturability of the system.

In some embodiments, the extraction chamber 114 may extend an entirety of the tube length 121. In some embodiments, the extraction chamber 114 may extend partially along the tube length 121. For example, the extraction chamber 114 may extend less than the entirety of the tube length 121 to facilitate connection of the extraction tube 106 with the first fluid processing system 102.

Transfer of the target ion across the wall of the extraction tube 106 may be or include a multi-step process. For example, as discussed herein, in some embodiments, the MOF on the walls of the extraction tube 106 may be formed to attract the target ion to the MOF. Based on this attraction, the target ion may pass into the pore spaces in the MOF. The target ion may then be released into the eluent. For example, the target ion may be released into the eluent based on a difference in conditions between the brine and the eluent, such as the eluent concentration of the target ion in the eluent.

In some embodiments, the target ion may be adsorbed on the MOF (e.g., the MOF may include an adsorbent material), and the target ion may be desorbed from the MOF based on the conditions of the eluent, such as the temperature, concentration, electrical charge, chemical composition, or other conditions of the eluent.

In some embodiments, the target ion may transport and/or pass across the MOF based on size exclusion. For example, the pore size of the MOF may be selected to allow the target ion to pass across the MOF while preventing larger ions from passing across the MOF.

The resulting eluate (e.g., the eluent that has an increased concentration of the extracted target ion) may be passed from the extraction chamber 114 to the eluate storage 120. The ion extraction system 100 may be arranged to pump the eluent and the eluate through the extraction chamber 114 in any manner. For example, the second fluid processing system 104 may be arranged in a batch-based system. In a batch-based system, the eluent may be pumped into the interior of the extraction chamber 114. After the eluent is pumped into the extraction chamber 114, the eluent pump 116 may be turned off, and no additional eluent may be pumped into the extraction chamber 114. The target ion may be extracted across the extraction tube 106 until the eluate has reached a threshold concentration of the target ion and/or until a threshold amount of time has passed. The eluent pump 116 (or another eluent pump between the extraction chamber 114 and the eluate storage 120) may pump the eluate from the extraction chamber 114 to the eluate storage 120. After the eluate is pumped out of the extraction chamber 114, the eluent pump 116 may fill the extraction chamber 114 with eluent again, and the process repeated.

In accordance with at least one embodiment of the present disclosure, the second fluid processing system 104 may be arranged in a continuous flow. For example, the eluent pump 116 may continuously flow eluent from the eluent storage 118 into the extraction chamber 114. The target ion may be extracted from the extraction tube 106 as the eluent is pumped into and out of the extraction chamber 114. This may improve the efficiency of the ion extraction system 100.

In some embodiments, the first fluid processing system 102 may be arranged in a batch-based or a continuous operation system. For example, the brine pump 108 may pump the brine having a high concentration of the target ion into the extraction tube 106. In a batch-based system, the brine pump 108 may pump the brine into the extraction tube 106, and the brine may remain in the extraction tube 106 until the target ion has been extracted from the brine and the brine is below a threshold concentration. The brine pump 108 may then pump the depleted brine out of the extraction tube 106 and into the target ion lean storage 112. In a continuous operation system, the brine pump 108 may pump brine through the extraction tube 106 with a continuous flow, and the target ion may be extracted as the brine passes through the extraction tube 106 and into the target ion lean storage 112.

As discussed in further detail herein, the second fluid processing system 104 and the first fluid processing system 102 may be arranged in a counter-current flow. For example, the first fluid processing system 102 may pump the brine in a first direction, and the second fluid processing system 104 may pump the eluent in a second direction opposite (or at least partially opposite) the first direction. This may facilitate increased extraction efficiency of the target ion from the brine.

In accordance with at least one embodiment of the present disclosure, the ion extraction system 100 may include an automated control loop to manage the flow of the brine and the eluent. For example, the ion extraction system 100 may include one or more concentration sensors in the target ion rich storage 110, the target ion lean storage 112, the eluent storage 118, and the eluate storage 120. The brine pump 108 and the eluent pump 116 may pump the brine and the eluent with variable flow rates. In some embodiments, the flow rates of the brine and the eluent may be based on the measured concentrations of the brine and eluent in one or more of the target ion rich storage 110, the target ion lean storage 112, or the eluate storage 120. For example, the concentration of the brine in the target ion rich storage 110 may determine the flow rate of the brine through the extraction tube 106 and/or the flow rate of the eluent through the extraction chamber 114. In some examples, the concentration of the depleted brine in the target ion lean storage 112 may be used to determine whether the flow rate through the extraction tube 106 is too fast or too slow. In some examples, the concentration of the eluate in the eluate storage 120 may be used to determine whether the flow rate through the extraction chamber 114 is too fast or slow. In this manner, the operator may improve the efficiency of the ion extraction system 100 by managing the flow rate based on the concentration of one or more of the target ion rich storage 110, the target ion lean storage 112, the eluent storage 118, or the eluate storage 120.

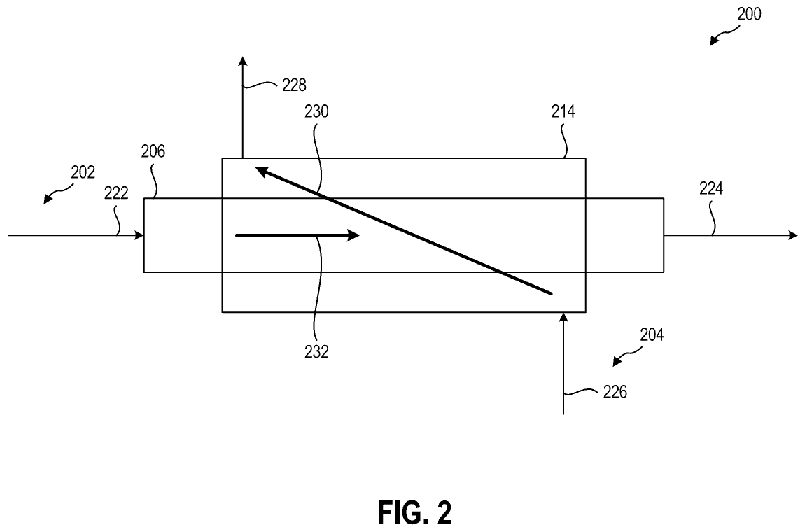

FIG. 2 is a schematic representation of an ion extraction system 200, according to at least one embodiment of the present disclosure. The ion extraction system 200 includes an extraction tube 206 and an extraction chamber 214 at least partially surrounding the extraction tube 206. The ion extraction system 200 includes a first fluid processing system 202 arranged to pump a brine through the extraction tube 206 from a brine inlet 222 of the extraction tube 206 to a brine outlet 224 of the extraction tube 206. The ion extraction system 200 further includes a second fluid processing system 204 arranged to pump an eluent from a chamber inlet 226 to a chamber outlet 228.

In the ion extraction system 200 shown, the first fluid processing system 202 and the second fluid processing system 204 are arranged in a counter-current arrangement. For example, the chamber inlet 226 may be closer to the brine outlet 224 than the brine inlet 222, and the chamber outlet 228 may be closer to the brine inlet 222 than the brine outlet 224. In this manner, eluent pumped into the extraction chamber 214 at the chamber inlet 226 having the lowest eluent concentration of the target ion may be in contact with the extraction tube 206 near the brine outlet 224. The brine in the extraction tube 206 may have the lowest brine concentration of the target ion at or near the brine outlet 224. The eluent near the chamber outlet 228 may have a higher eluent concentration of the target ion. The brine near the chamber outlet 228 may have a higher brine concentration of the target ion. In this manner, the concentration difference between the eluent and the brine may be increased, thereby increasing the extraction efficiency of the ion extraction system 200 throughout the length of the ion extraction system 200.

The eluent flow of the eluent may be in an eluent flow direction 230, which may be the average direction of eluent flow through the extraction chamber 214 from the chamber inlet 226 to the chamber outlet 228. The brine flow of the brine may be in a brine flow direction 232, which may be the average direction of brine flow through the extraction tube 206 from the brine inlet 222 to the brine outlet 224. In accordance with at least one embodiment of the present disclosure, the eluent flow direction 230 may be at least partially opposite the brine flow direction 232. In the embodiment shown, the eluent flow direction 230 is at least partially opposite and partially perpendicular to the brine flow direction 232.

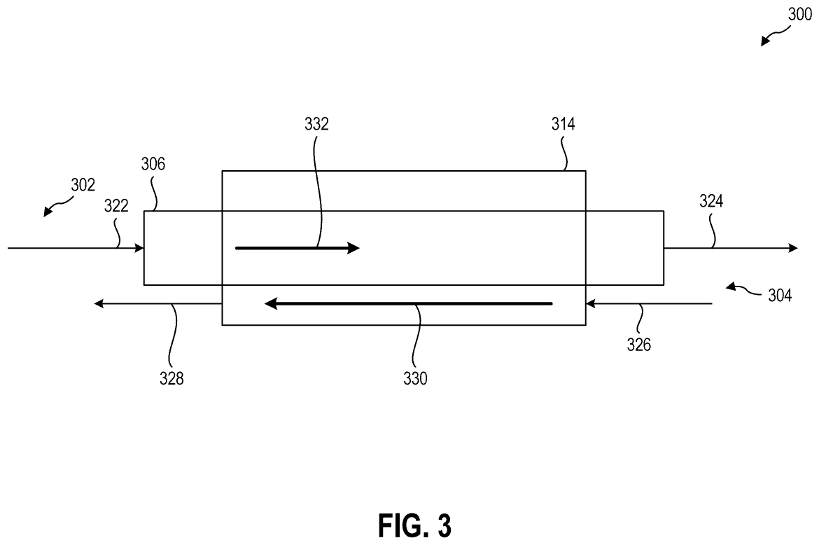

FIG. 3 is a schematic representation of an ion extraction system 300, according to at least one embodiment of the present disclosure. The ion extraction system 300 includes an extraction tube 306 and an extraction chamber 314 at least partially surrounding the extraction tube 306. The ion extraction system 300 includes a first fluid processing system 302 arranged to pump a brine through the extraction tube 306 from a brine inlet 322 of the extraction tube 306 to a brine outlet 324 of the extraction tube 306. The ion extraction system 300 further includes a second fluid processing system 304 arranged to pump an eluent from a chamber inlet 326 to a chamber outlet 328.

In the ion extraction system 300 shown, the first fluid processing system 302 and the second fluid processing system 304 are arranged in a counter-current arrangement. For example, the chamber inlet 326 may be closer to the brine outlet 324 than the brine inlet 322, and the chamber outlet 328 may be closer to the brine inlet 322 than the brine outlet 324. In this manner, eluent pumped into the extraction chamber 314 at the chamber inlet 326 having the lowest eluent concentration of the target ion may be in contact with the extraction tube 306 near the brine outlet 324. The brine in the extraction tube 306 may have the lowest brine concentration of the target ion at or near the brine outlet 324. The eluent near the chamber outlet 328 may have a higher eluent concentration of the target ion. The brine near the chamber outlet 328 may have a higher brine concentration of the target ion. In this manner, the concentration difference between the eluent and the brine may be increased, thereby increasing the extraction efficiency of the ion extraction system 300 throughout the length of the ion extraction system 300.

The eluent flow of the eluent may be in an eluent flow direction 330, which may be the average direction of eluent flow through the extraction chamber 314 from the chamber inlet 326 to the chamber outlet 328. The brine flow of the brine may be in a brine flow direction 332, which may be the average direction of brine flow through the extraction tube 306 from the brine inlet 322 to the brine outlet 324. In the embodiment shown, the eluent flow direction 330 is opposite to the brine flow direction 332.

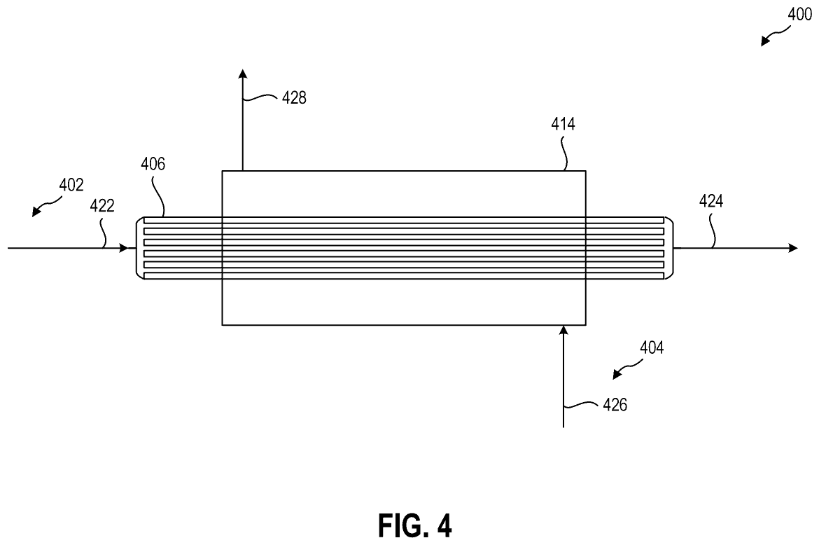

FIG. 4 is a schematic representation of an ion extraction system 400, according to at least one embodiment of the present disclosure. The ion extraction system 400 includes multiple extraction tubes 406 and an extraction chamber 414 at least partially surrounding the extraction tubes 406. The ion extraction system 400 includes a first fluid processing system 402 arranged to pump a brine through the extraction tubes 406 from a brine inlet 422 of the extraction tube 406 to a brine outlet 424 of the extraction tubes 406. The ion extraction system 400 further includes a second fluid processing system 404 arranged to pump an eluent from a chamber inlet 426 to a chamber outlet 428.

In the embodiment shown, the ion extraction system 400 includes multiple extraction tubes 406. As discussed herein, the extraction of the target ion from the brine includes transfer of the target ion across the walls of the extraction tubes 406. To reduce the transfer distance of the target ion in the brine to the walls of the extraction tube 206, thereby increasing the extraction rate of the target ion, the extraction tubes 406 may have a smaller diameter. This may increase the surface area of the walls of the extraction tubes 406, thereby increasing the rate of transfer of the target ion across the walls.

The extraction tubes 406 may be arranged with a gap or other spacing between them. The gap or spacing may facilitate the contact with the walls and flow of the eluent around the extraction tubes 406. In some embodiments, the extraction tubes 406 may extend parallel through the extraction chamber 414. In some embodiments, the extraction tubes 406 may extend straight through the extraction chamber 414. In some embodiments, the extraction tubes 406 may include one or more curves, bends, spirals, or turns to increase the travel length through the extraction chamber 414.

In accordance with at least one embodiment of the present disclosure, the ion extraction system 400 may include various support or other structural elements. For example, the ion extraction system 400 may include potting at one or both ends of the extraction tubes 406 to secure the position and orientation of the extraction tubes 406 with respect to the super structure. In some embodiments, the brine inlet 422 may include a feed distributor, which may include a manifold or other outlet that may distribute the brine through across the tubes of the extraction tubes 406. In the embodiment illustrated, the chamber inlet 426 and chamber outlet 428 may be shell-side feeds, or may insert into the curved circumferential surface of the extraction chamber 414. In some embodiments, the chamber inlet 426 and the chamber outlet 428 may be bore-side feeds, or may insert into the longitudinal ends of the extraction chamber 414. In some embodiments, the brine inlet 422 and the brine outlet 424 may be bore-side or shell-side feeds.

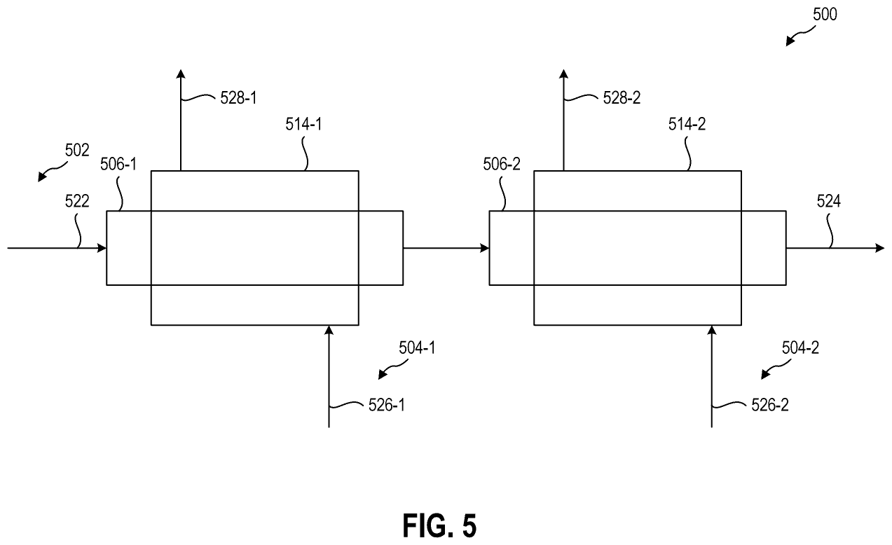

FIG. 5 is a schematic representation of an ion extraction system 500, according to at least one embodiment of the present disclosure. The ion extraction system 500 includes multiple extraction tubes (collectively) 506 and extraction chambers (collectively 514) at least partially surrounding the extraction tubes 506. The ion extraction system 500 includes a first fluid processing system 502 arranged to pump a brine through the extraction tubes 506 from a brine inlet 522 of the extraction tube 506 to a brine outlet 524 of the extraction tubes 506. The ion extraction system 500 further includes an eluent processing system (collectively 504) arranged to pump an eluent from a chamber inlet (collectively 526) to a chamber outlet (collectively 528).

In the embodiment shown, the ion extraction system 500 is configured or arranged to extract multiple target ions from a brine. For example, the ion extraction system 500 includes a first extraction tube 506-1 in a first extraction chamber 514-1. The first extraction tube 506-1 includes a first elective membrane, such as a first MOF, selected to selectively transport a first target ion from the brine. A first eluent processing system 504-1 may pump a first eluent into the first extraction chamber 514-1 via a first chamber inlet 526-1 and out of the first extraction chamber 514-1 via a first chamber outlet 528-1.

The ion extraction system 500 includes a second extraction tube 506-2 in a second extraction chamber 514-2. The second extraction tube 506-2 includes a second elective membrane, such as a second MOF, selected to selectively transport a second target ion from the brine (e.g., the brine that is depleted of the first target ion). A second eluent processing system 504-2 may pump a second eluent into the second extraction chamber 514-2 via a second chamber inlet 526-2 and out of the second extraction chamber 514-2 via a second chamber outlet 528-2.

The first extraction tube 506-1 and the second extraction tube 506-2 may be arranged in series. For example, the output of the first extraction tube 506-1 may be input into the second extraction tube 506-2. In some examples, the first extraction tube 506-1 may be connected or linked to the second extraction tube 506-2. In some examples, the first extraction tube 506-1 and the second extraction tube 506-2 may include one or more holding tanks or processing systems therebetween.

The first extraction chamber 514-1 and the second extraction chamber 514-2 may be separated from each other. For example, the first chamber inlet 526-1 and the first chamber outlet 528-1 may be part of a separate piping or other flow system than the second chamber inlet 526-2 and the second chamber outlet 528-2. The first eluent used in the first eluent processing system 504-1 may be tailored to the first target ion, and the second eluent used in the second eluent processing system 504-2 may be tailored to the second target ion. This may facilitate the separation and concentration of different target ions.

The first extraction tube 506-1 and the second extraction tube 506-2 may be arranged in any order. For example, the first extraction tube 506-1 and the second extraction tube 506-2 may be arranged based on the size of the target ion each extraction tube 506 is configured to extract. For example, the first target ion of the first extraction tube 506-1 may have a smaller radius than the second target ion of the second extraction tube 506-2. In some embodiments, the first extraction tube 506-1 may have a first MOF that selectively transports the first target ion and the second extraction tube 506-2 may have a second MOF that selectively transports the second target ion.

While the embodiment of FIG. 5 is illustrated with two extraction tubes 506 directed to extracting two different target ions, it should be understood that the techniques of the present disclosure may be applied to any number of extraction tubes 506. For example, the techniques of the present disclosure may be applied to 2, 3, 4, 5, 6, 7, 8, 9, 10, or more extraction tubes 506 extracting multiple different target ions.

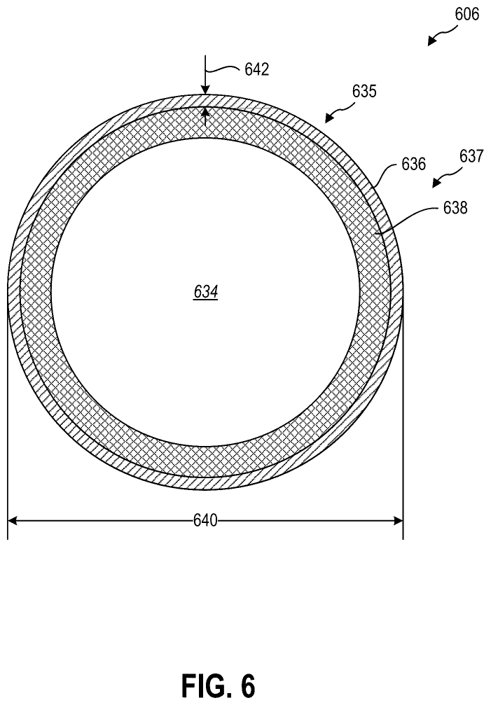

FIG. 6 is a representation of a cross-sectional view of an extraction tube 606, according to at least one embodiment of the present disclosure. The extraction tube 606 includes an interior 634. A brine may flow through the interior 634. The extraction tube 606 may include a wall 635. The wall 635 may include an elective membrane 637. A discussed herein, the elective membrane 636 may include a MOF or other material that may be configured to or selected to selectively transport a target ion. A target ion from the interior 634 of the extraction tube 606 may travel across the wall 635 based on the properties and/or composition of the elective membrane 636.

In some embodiments, the elective membrane 636 may form an entirety of the wall 635. For example, the elective membrane 636 may include a MOF 636. In some embodiments, the MOF 636 may include a monolithic MOF or MOF body that is extruded, grown, or otherwise formed in the tubular shape of the extraction tube 606, thereby forming the entirety of the wall 635.

In some embodiments, the MOF 636 on the elective membrane 637 may be secured to, deposited on, grown on, or otherwise connected to a support structure 638. For example, the support structure 638 may include a membrane and the MOF 636 may be formed on the support structure 638 to form the elective membrane 637. In some embodiments, the support structure 638 may be formed from a ceramic, a fiber, or other material that may be sufficiently porous to not prevent or inhibit transfer of the target ion across the wall 635 while retaining sufficient structural stability to prevent damage to the extraction tube 606 during operation. While the MOF 636 is illustrated on the outer surface of the support structure 638, it should be understood that the MOF 636 may be formed the inner surface, or the outer surface and the inner surface of the support structure 638.

The extraction tube 606 has a tube diameter 640. In some embodiments, the tube diameter 640 may be in a range having an upper value, a lower value, or upper and lower values including any of 1 nm, 5 nm, 10 nm, 50 nm, 100 nm, 500 nm, 1 micrometer, 5 micrometers, 10 micrometers, 50 micrometers, 100 micrometers, 500 micrometers, 1 mm, 5 mm, 10 mm, 50 mm, 100 mm, 150 mm, 200 mm, 250 mm, or any value therebetween. For example, the tube diameter 640 may be greater than 1 nm. In another example, the tube diameter 640 may be less than 250 mm. In yet other examples, the tube diameter 640 may be any value in a range between 1 nm and 250 mm

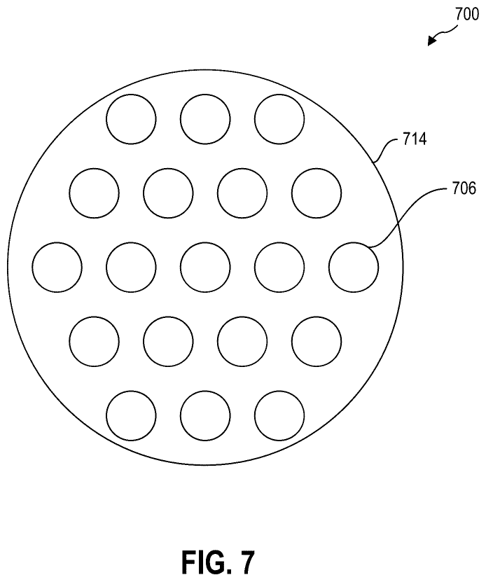

FIG. 7 is a schematic representation of a cross-sectional view of an ion extraction system 700, according to at least one embodiment of the present disclosure. The ion extraction system 700 includes multiple extraction tubes 706 located in an extraction chamber 714. The extraction tubes 706 may be arranged within the extraction chamber 714 to facilitate flow of the eluent around and between the outer surface of the extraction tubes 706. For example, the extraction tubes 706 may be spaced with a spacing to allow the eluent to contact the entirety of their outer surface and to flow between the extraction tubes 706 to allow new eluent to contact the outer surface of the extraction tubes 706. Including multiple extraction tubes 706 in the extraction chamber 714 may increase the surface area in contact with the eluent, thereby increasing the extraction efficiency of the ion extraction system 700.

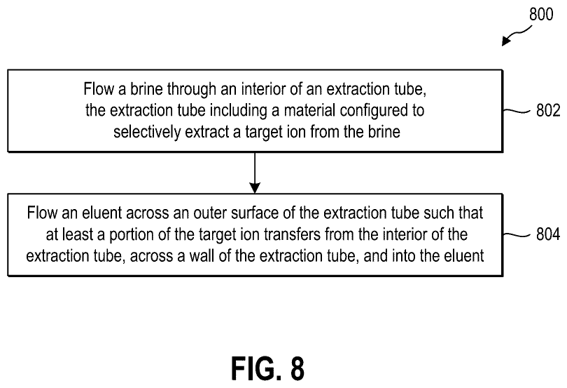

FIG. 8 is a flowchart of a sample method 800 for selective ion extraction, according to at least one embodiment of the present disclosure. An operator may flow a brine through an interior of an extraction tube at 802. The extraction tube includes a material configured to selectively transport a target ion from the brine. The operator may flow an eluent across an outer surface of the extraction tube such that at least a portion of the target ion transfers from the interior of the extraction tube, across a wall of the extraction tube, and into the eluent at 804.

In some embodiments, flowing the brine includes flowing the brine with a pressure configured to transfer the target ion across the material using physical pressure. In some embodiments, the eluent has an eluent concentration of the target ion that is lower than a brine concentration of the target ion. In some embodiments, the material includes a MOF having a pore size selected to extract the target ion without extracting larger ions. In some embodiments, flowing the eluent across the outer surface includes flowing the eluent in a direction opposite a flow of the brine.

In some embodiments, the target ion includes lithium. In some embodiments, flowing the eluent across the outer surface of the extraction tube includes flowing the eluent across the outer surface of the extraction tube in a first chamber. The material includes a first material in the first chamber selected to extract the lithium. The operator may further flow the eluent across the outer surface of the extraction tube in a second chamber. The material includes a second material in the second chamber selected to extract a second target ion.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers'specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. An ion extraction system, comprising:
at least one extraction tube;
an elective membrane at the at least one extraction tube, the elective membrane formed from a material to selectively transport a target ion from a brine in the extraction tube wherein material of the elective membrane includes a metal-organic framework (MOF); and
an extraction chamber surrounding at least a portion of the extraction tube, wherein an eluent in the extraction chamber is configured to extract the target ion from the brine.

2. The ion extraction system of claim 1, wherein the material of the elective membrane is selected to selectively transport the target ion using at least one of physical pressure, osmotic pressure, chemical potential, electrostatic field or magnetic field.

3. The ion extraction system of claim 1, wherein the extraction tube includes a support structure, and wherein the elective membrane is supported by the support structure.

4. The ion extraction system of claim 1, wherein the extraction tube includes a brine inlet and a brine outlet, and wherein the extraction chamber includes a chamber inlet and a chamber outlet, and wherein the chamber inlet is closer to the brine outlet than the brine inlet, and the chamber outlet is closer to the brine inlet than the brine outlet.

5. The ion extraction system of claim 4, further comprising:
a first fluid processing system arranged to pump the brine from the brine inlet to the brine outlet; and
a second fluid processing system arranged to pump an eluent from the chamber inlet to the chamber outlet.

6. The ion extraction system of claim 1, wherein the at least one extraction tube includes a plurality of extraction tubes arranged within the extraction chamber.

7. The ion extraction system of claim 1, wherein the material includes an adsorbent material selected to adsorb the target ion.

8. The ion extraction system of claim 1, wherein the extraction chamber includes a first extraction chamber located at a first portion of the extraction tube having a first portion of the elective membrane, and the target ion is a first target ion, and further comprising a second extraction chamber located at a second portion of the extraction tube having a second portion of the elective membrane, and wherein the second portion of the elective membrane is configured to selectively transport a second target ion.

9. The ion extraction system of claim 8, wherein the first portion of the elective membrane includes a first MOF selected to selectively transport the first target ion and the second portion of the elective membrane includes a second MOF selected to selectively transport the second target ion, the second target ion having a larger diameter than the first target ion.

10. The ion extraction system of claim 1, wherein the MOF includes one or more MOF crystals connected by a bonding agent comprising a MOF formed in a non-crystallized or amorphous state.

11. A method for selective ion extraction, the method comprising:
flowing a brine through an interior of at least one extraction tube, the extraction tube including a material configured to selectively transport a target ion from the brine, wherein the material includes a metal-organic framework (MOF); and
flowing an eluent across an outer surface of the extraction tube such that at least a portion of the target ion transfers from the interior of the extraction tube, across a wall of the extraction tube, and into the eluent.

12. The method of claim 11, wherein flowing the brine includes flowing the brine with a pressure configured to transfer the target ion across the material using physical pressure.

13. The method of claim 11, wherein the eluent has an eluent concentration of the target ion that is lower than a brine concentration of the target ion.

14. The method of claim 13, wherein the MOF has a pore size selected to extract the target ion without extracting larger ions.

15. The method of claim 11, wherein flowing the eluent across the outer surface includes flowing the eluent in a direction opposite a flow of the brine.

16. The method of claim 11, wherein the target ion includes lithium.

17. The method of claim 16, wherein flowing the eluent across the outer surface of the extraction tube includes flowing the eluent across the outer surface of the extraction tube in a first chamber, wherein the material includes a first material in the first chamber selected to extract the lithium, and further comprising flowing the eluent across the outer surface of the extraction tube in a second chamber, wherein the material includes a second material in the second chamber selected to extract a second target ion.

18. An ion extraction system, comprising:
a first fluid processing system arranged to pump a brine from a target ion rich storage to a target ion lean storage, the brine including a target ion, the first fluid processing system including at least one extraction tube between the target ion rich storage and the target ion lean storage; and
a second fluid processing system arranged to pump an eluent from an eluent storage to an eluate storage, the second fluid processing system including a chamber at least partially surrounding the at least one extraction tube, the chamber located between the eluent storage and the eluate storage, the at least one extraction tube including an elective membrane selected to selectively transport the target ion from the brine to the eluent in the chamber.

19. The ion extraction system of claim 18, wherein the second fluid processing system is arranged to pump the eluent counter-current to a flow of the brine.

20. The ion extraction system of claim 18, wherein the at least one extraction tube includes a plurality of extraction tubes arranged in the chamber.
